(19) United States
(12) Patent Application Publication
(10) Pub. No.: US 2025/0103063 A1
(43) Pub. Date: Mar. 27, 2025

(54) CONTROL SYSTEM, CONTROL METHOD, STORAGE MEDIUM, AND MOBILE OBJECT

(71) Applicant: HONDA MOTOR CO., LTD., Tokyo (JP)

(72) Inventors: Sango Matsuzaki, Wako-shi (JP); Misa Komuro, Wako-shi (JP)

(21) Appl. No.: 18/885,780

(22) Filed: Sep. 16, 2024

(30) Foreign Application Priority Data
Sep. 27, 2023 (JP) 2023-166449

(51) Int. Cl. G05D 1/686; G05D 105/28; G05D 107/17

(52) U.S. Cl. CPC G05D 1/686; G05D 2105/28; G05D 2107/17

(57) ABSTRACT

A control system for controlling a mobile object that is able to move autonomously in an area in which a pedestrian is able to move and moves to follow a target pedestrian performs: recognizing an object near the target pedestrian and the mobile object; determining a stop position other than a set area which the mobile object is prohibited from entering as a stop position based on a type of the set area when the target pedestrian enters the set area; and stopping following the target pedestrian and moving the mobile object to the determined stop position.

### CROSS-REFERENCE TO RELATED APPLICATION

Priority is claimed on Japanese Patent Application No. 2023-166449, filed Sep. 27, 2023, the content of which is incorporated herein by reference.

### BACKGROUND

### Field of the Invention

The present invention relates to a control system, a control method, a storage medium, and a mobile object.

### Description of Related Art

In the related art, a robot that guides a user to a desired place or carries luggage is known (Japanese Unexamined Patent Application, First Publication No. 2012-111011).

However, in this system, a stop position of a mobile object has not been sufficiently studied.

The present invention was made in consideration of the aforementioned circumstances, and an objective thereof is to provide a control system, a control method, a storage medium, and a mobile object that can determine a position based on a surrounding environment.

### SUMMARY

A control system, a control method, a storage medium, and a mobile object according to the present invention employ the following configurations.

(1) According to an aspect of the present invention, there is provided a control system for controlling a mobile object that is able to move autonomously in an area in which a pedestrian is able to move and moves to follow a target pedestrian, the control system including: a storage medium storing computer-readable instructions; and one or more processors connected to the storage medium, wherein the one or more processors execute the computer-readable instructions to perform: recognizing an object near the target pedestrian and the mobile object; determining a stop position other than a set area which the mobile object is prohibited from entering as a stop position based on a type of the set area when the target pedestrian enters the set area; and stopping following the target pedestrian and moving the mobile object to the determined stop position.

(2) In the aspect of (1), the one or more processors may execute the computer-readable instructions to perform recognizing a type of the set area on the basis of a type of the recognized object or recognizing a type of the set area on the basis of a type of a set area which is correlated with a position of the mobile object in map information.

(3) In the aspect of (1), the stop position based on a type of the set area may be a position in the vicinity of the set area at which another pedestrian is estimated not to be hindered from entering the set area.

(4) In the aspect of (1), the one or more processors may execute the computer-readable instructions to perform: determining a position on an exit side of a facility in which a checkout counter is installed or a position of an exit of the checkout counter as the stop position when a target object indicating that the set area is a set area for the checkout counter is recognized and the set area is recognized as a set area for the checkout counter; and moving the mobile object to the stop position.

(5) In the aspect of (4), the target object may be a checkout counter or a shopping cart.

(6) In the aspect of (1), the one or more processors may execute the computer-readable instructions to perform determining the stop position according to a time after the target pedestrian or the mobile object has entered a facility of the set area and until the target pedestrian enters the set area when the target pedestrian or the mobile object enters the set area.

(7) In the aspect of (1), the one or more processors may execute the computer-readable instructions to perform determining a position farther from an entrance of a facility in which a counter is installed than the target pedestrian as the stop position when the set area is the counter of the facility, the target pedestrian enters a set area for the counter, and a predetermined first time does not elapse after the target pedestrian or the mobile object enters the facility.

(8) In the aspect of (1), the one or more processors may execute the computer-readable instructions to perform determining a position closer to an exit of a facility than the target pedestrian as the stop position when the set area is a counter of the facility, the target pedestrian enters a set area for the counter, and a predetermined second time or more elapses after the target pedestrian or the mobile object enters the facility.

(9) In the aspect of (1), the one or more processors may execute the computer-readable instructions to perform determining a position in front of or behind the target pedestrian in a moving direction of the target pedestrian as the stop position based on the type of the set area and other than the set area when the target pedestrian enters the set area which the mobile object is prohibited from entering.

(10) In the aspect of (1), the one or more processors may execute the computer-readable instructions to perform: determining a predetermined area before a toilet as the stop position when the set area is recognized as the toilet; and moving the mobile object to the stop position.

(11) In the aspect of (10), the predetermined area before the toilet may be an area outside of the toilet and within a predetermined range from an entrance of the toilet.

(12) In the aspect of (1), the one or more processors may execute the computer-readable instructions to perform causing the mobile object to restart following the target pedestrian when the target pedestrian exits the set area after the mobile object has stopped at the stop position with entering of the target pedestrian into the set area.

(13) In the aspect of (12), the one or more processors may execute the computer-readable instructions to perform causing the mobile object not to enter the set area and to restart following the target pedestrian when the target pedestrian exits the set area after the mobile object has stopped at the stop position.

(14) According to another aspect of the present invention, there is provided a control method that is performed by a computer of a control system for controlling a mobile object that is able to move autonomously in an area in which a pedestrian is able to move and moves to follow a target pedestrian, the control method including: recognizing an object near the target pedestrian and the mobile object; determining a stop position other than a set area which the mobile object is prohibited from entering as a stop position based on a type of the set area when the target pedestrian enters the set area; and stopping following the target pedestrian and moving the mobile object to the determined stop position.

(15) According to another aspect of the present invention, there is provided a non-transitory computer storage medium storing a program causing a computer of a control system for controlling a mobile object that is able to move autonomously in an area in which a pedestrian is able to move and moves to follow a target pedestrian to perform: a process of recognizing an object near the target pedestrian and the mobile object; a process of determining a stop position other than a set area which the mobile object is prohibited from entering as a stop position based on a type of the set area when the target pedestrian enters the set area; and a process of stopping following the target pedestrian and moving the mobile object to the determined stop position.

(16) According to another aspect of the present invention, there is provided a mobile object that is able to move autonomously in an area in which a pedestrian is able to move and moves to follow a target pedestrian, the mobile object performing: recognizing an object near the target pedestrian and the mobile object; determining a stop position other than a set area which the mobile object is prohibited from entering as a stop position based on a type of the set area when the target pedestrian enters the set area; and stopping following the target pedestrian and moving to the determined stop position.

According to the aspects of (1) to (16), it is possible to determine a stop position based on a surrounding environment.

### BRIEF DESCRIPTION OF THE DRAWINGS

FIG. 1 is a diagram illustrating an example of a configuration of a mobile object system including a mobile object.

FIG. 2 is a diagram illustrating an example of a usage mode of a mobile object.

FIG. 3 is a diagram illustrating a guidance mode.

FIG. 4 is a perspective view illustrating a mobile object.

FIG. 5 is a diagram illustrating an example of a functional configuration of a mobile object.

FIG. 6 is a diagram illustrating an example of details of stop position information.

FIG. 7 is a (first) diagram illustrating Situation 1.

FIG. 8 is a (second) diagram illustrating Situation 1.

FIG. 9 is a diagram illustrating Situation 2-1.

FIG. 10 is a diagram illustrating Situation 2-2.

FIG. 11 is a diagram illustrating Situation 3.

FIG. 12 is a flowchart illustrating an example of a process flow that is performed by a control device.

### DETAILED DESCRIPTION

Hereinafter, a control system, a control method, a storage medium, and a mobile object according to the present invention will be described with reference to an embodiment of the accompanying drawings. The control system according to the present invention controls a drive device of a mobile object such that the mobile object moves. A mobile object in the present invention moves autonomously to follow a target person in an area in which a pedestrian is able to walk while guiding a guidance target person. The mobile object is able to move in an area in which a vehicle (an automobile, motorbike, or a compact car) is not able to move and a pedestrian is able to move. The area in which a pedestrian is able to move may include a walkway, a public open space, and a floor in a building and may also include a roadway. In the following description, it is assumed that no person boards the mobile object, but a person may board the mobile object. A guidance target person is, for example, a pedestrian alone and may be a robot or an animal. The mobile object moves, for example, a little in front of a user who is an aged person while moving to a predetermined destination and thus operates such that another pedestrian who will serve as an obstacle for movement of the user does not approach the user too closely (that is, operates such that a passage is made for the user). The user is not limited to an aged person and may be a person having difficulty walking, a child, a person shopping in a supermarket, a patient moving in a hospital, or a pet taking a walk. The user does not have to determine a destination in advance, and the mobile object may predict a direction in which the user will move and move autonomously in front of the user according to a moving speed of the user. This operation does not need to be performed constantly and may be performed temporarily. For example, when the mobile object moves parallel with the user or tracks the user and detects a predetermined situation (for example, presence of an obstacle or traffic congestion) in the moving direction of the user, the mobile object may temporarily guide the user by performing an algorithm according to the present invention.

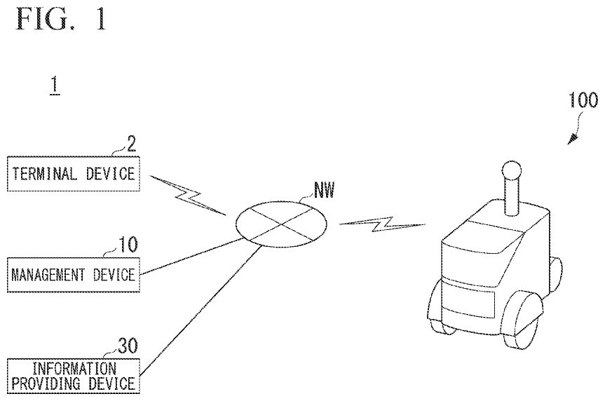

FIG. 1 is a diagram illustrating an example of a configuration of a mobile object system 1 including a mobile object 100. A mobile object system (“control system”) 1 includes, for example, one or more terminal devices 2, a management device 10, an information providing device 30, and one or more mobile objects 100. These constituents communicate with each other, for example, via a network NW. The network NW is, for example, an arbitrary network such as a LAN, a WAN, or an Internet line. Some of functional units of the information providing device 30 may be mounted in a mobile object 100, and some of functional units of the mobile object 100 may be mounted in the information providing device 30.

### Terminal Device

A terminal device 2 is, for example, a computer device such as a smartphone or a tablet terminal. The terminal device 2 requests the management device 10 to provide a right to use of a mobile object 100, for example, on the basis of a user's operation or acquires information indicating that the use is permitted.

### Management Device

The management device 10 gives the right to use of a mobile object 100 to a user of a terminal device 2 in response to a request from the terminal device 2 or manages a reservation for use of the mobile object 100. The management device 10 generates and manages schedule information in which identification of a user registered in advance and a date and time of a reservation for use of a mobile object 100 are correlated.

### Information Providing Device

The information providing device 30 provides a position at which a mobile object 100 is present, an area in which the mobile object 100 can move, and map information near the area to the mobile object 100. The information providing device 30 may generate a route to a destination of a mobile object 100 in response to a request from the mobile object 100 and provide the generated route to the mobile object 100.

### Mobile Object

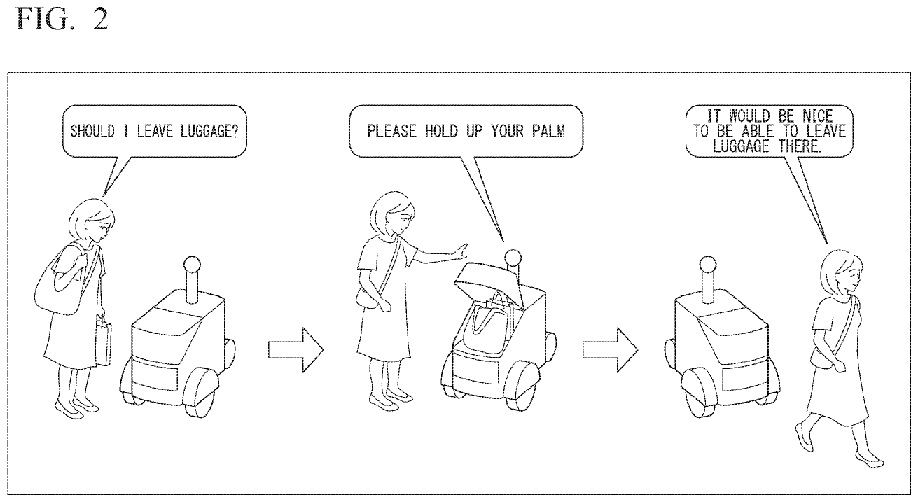

A mobile object 100 is used by a user in the following usage modes. FIG. 2 is a diagram illustrating an example of usage modes of a mobile object 100. A mobile object 100 can move autonomously in an area in which a pedestrian is able to move. The mobile object 100 can move, for example, in an area in which no vehicle should move. The mobile object 100 is disposed, for example, at a predetermined position on a facility or a street. When a user wants to use the mobile object 100, the user can operate an operation unit (not illustrated) of the mobile object 100 to start use of the mobile object 100 or can operate the terminal device 2 to start use of the mobile object 100. For example, when a user has completed shopping and has more luggage, the user starts use of the mobile object 100 and puts the luggage into a housing unit of the mobile object 100. Then, the mobile object 100 moves autonomously along with the user to follow the user. The user can continue to do shopping or go to a next destination in a state in which the luggage is housed in the mobile object 100. For example, the mobile object 100 moves along with the user while moving on a walkway or a crosswalk of a roadway. The mobile object 100 can move in an area in which a pedestrian is able to move such as a roadway and a walkway. For example, the mobile object 100 can be used in indoor or outdoor facilities such as a shopping mall, an airport, a park, and a theme park or private land and can move in an area in which a pedestrian is able to move.

The mobile object 100 may be able to move autonomously in a mode such as a guidance mode or an emergency mode in addition to (or instead of) a following mode in which the mobile object 100 follows a user as described above.

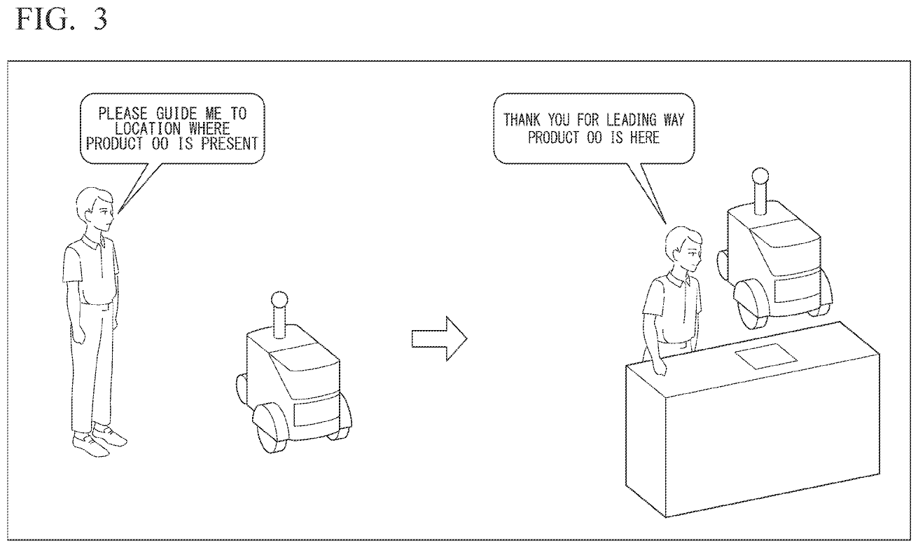

FIG. 3 is a diagram illustrating the guidance mode. The guidance mode is a mode in which a user is guided to a destination designated by the user and is a mode in which the user is guided by moving autonomously according to a moving speed of the user in front of the user. When a user is finding a predetermined product in a shopping center as illustrated in FIG. 3 and the user requests the mobile object 100 to guide the user to a place of the predetermined product, the mobile object 100 guides the user to the place of the product. Accordingly, the user can easily find the predetermined product. When the mobile object 100 is used in a shopping center, the mobile object 100 or the information providing device 30 stores information in which a place of a product, a place of a store, a place of a facility in the shopping center, and the like are correlated with map information and map information of the shopping center. The map information includes detailed map information including widths of roads or passages.

The emergency mode is a mode in which the mobile object 100 moves autonomously to help a user and to ask a nearby person or a nearby facility for help when an emergency occurs for the user while moving along with the user (for example, when the user falls). The mobile object 100 may move while maintaining a distance from the user in addition to (or instead of) following or guidance as described above.

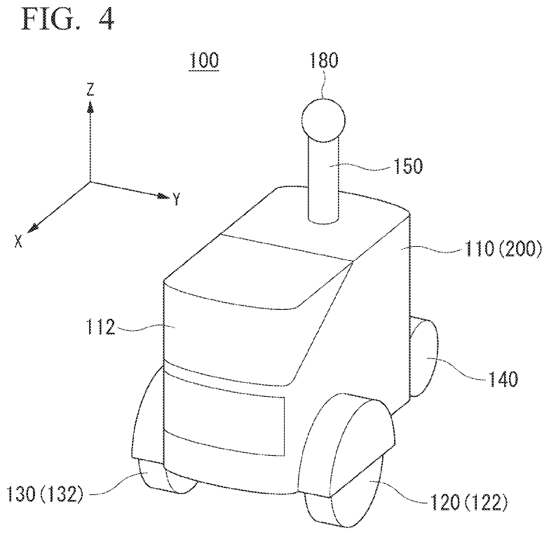

FIG. 4 is a perspective view illustrating a mobile object 100. In the following description, a forward direction of the mobile object 100 is defined as a plus x side, a rearward direction of the mobile object 100 is defined as a minus x side, a width direction of the mobile object 100 which is a left side with respect to the plus x side is defined as a plus y side, and a right side is defined as a minus y side, and a direction perpendicular to the x direction and the y direction which is a height direction of the mobile object 100 is defined as a plus z side.

The mobile object 100 includes, for example, a base 110, a door 112 provided in the base 110, and wheels (a first wheel 120, a second wheel 130, and a third wheel 140) assembled into the base 110. For example, a user can open the door 112 and put luggage into a housing unit provided in the base 110 or take out luggage from the housing unit. The first wheel 120 and the second wheel 130 are driving wheels, and the third wheel 140 is an auxiliary wheel (driven wheel). The mobile object 100 may be able to move using an element other than the wheels such as a caterpillar.

A cylindrical support 150 extending to the plus z side on the surface on the plus z side of the base 110. A camera 180 for imaging the surroundings of the mobile object 100 is provided at an end on the plus z side of the support 150. The position at which the camera 180 is provided may be an arbitrary position other than described above.

The camera 180 is, for example, a camera that can image the surroundings of the mobile object 100 at a wide angle (for example, 360 degrees). The camera 180 may include a plurality of cameras. The camera 180 may be realized, for example, as a combination of a plurality of 120-degree cameras or a combination of a plurality of 60-degree cameras.

FIG. 5 is a diagram illustrating an example of a functional configuration of the mobile object 100. The mobile object 100 includes a first motor 122, a second motor 132, a battery 134, a brake device 136, a steering device 138, a communication unit 190, and a control device 200 in addition to the functional configuration illustrated in FIG. 4. The first motor 122 and the second motor 132 operate with electric power supplied from the battery 134. The first motor 122 drives the first wheel 120, and the second motor 132 drives the second wheel 130. The first motor 122 may be an in-wheel motor provided in a wheel of the first wheel 120, and the second motor 132 may be an in-wheel motor that is provided in a wheel of the second wheel 130.

The brake device 136 outputs brake torques to the wheels on the basis of an instruction from the control device 200. The steering device 138 includes an electric motor. For example, the electric motor applies a force to a rack-and-pinion mechanism on the basis of an instruction from the control device 200 to change the direction of the first wheel 120 or the second wheel 130 and to change a course of the mobile object 100.

The communication unit 190 is a communication interface that communicates with the terminal device 2, the management device 10, or the information providing device 30.

### Control Device

The control device 200 includes, for example, a position identification unit 202, an information processing unit 204, a recognition unit 206, a stop position processing unit 208, a route generation unit 212, a trajectory generation unit 214, a control unit 216, and a storage unit 220. The position identification unit 202, the information processing unit 204, the recognition unit 206, the route generation unit 212, the trajectory generation unit 214, and the control unit 216 are realized, for example, by causing a hardware processor such as a central processing unit (CPU) to execute a program (software). Some or all of these constituents may be realized by hardware (a circuit unit; including circuitry) such as a large scale integration (LSI) circuit, an application-specific integrated circuit (ASIC), a field-programmable gate array (FPGA), or a graphics processing unit (GPU) or may be cooperatively realized by software and hardware. The program may be stored in a storage device (a storage device including a non-transitory storage medium) such as a hard disk drive (HDD) or a flash memory or may be stored in a detachable storage medium (a non-transitory storage medium) such as a DVD or a CD-ROM and installed by setting the storage medium into a drive device. The storage unit 220 is realized by a storage device such as an HDD, a flash memory, or a random access memory (RAM). The stop position processing unit 208 is an example of an “identification unit.”

The storage unit 220 stores control information 222 which is a control program for controlling behavior of the mobile object 100, map information 224, set area information 226, and stop position information 228 which are referred to by the control unit 216. The map information 224 is, for example, map information of a position of the mobile object 100, an area in which the mobile object 100 moves, and peripheries of the area which is provided by the information providing device 30.

The set area information 226 indicates a predetermined area which the mobile object 100 is prohibited from entering. The area of which entering is prohibited is an area in which there is a high risk of interference with behavior of a traffic participant such as a pedestrian when a mobile object enters the area. The area of which entering is prohibited is, for example, an area including a counter (a checkout counter) of a facility, peripheries thereof, or an entrance. The position of a set area may be correlated with the map information 224.

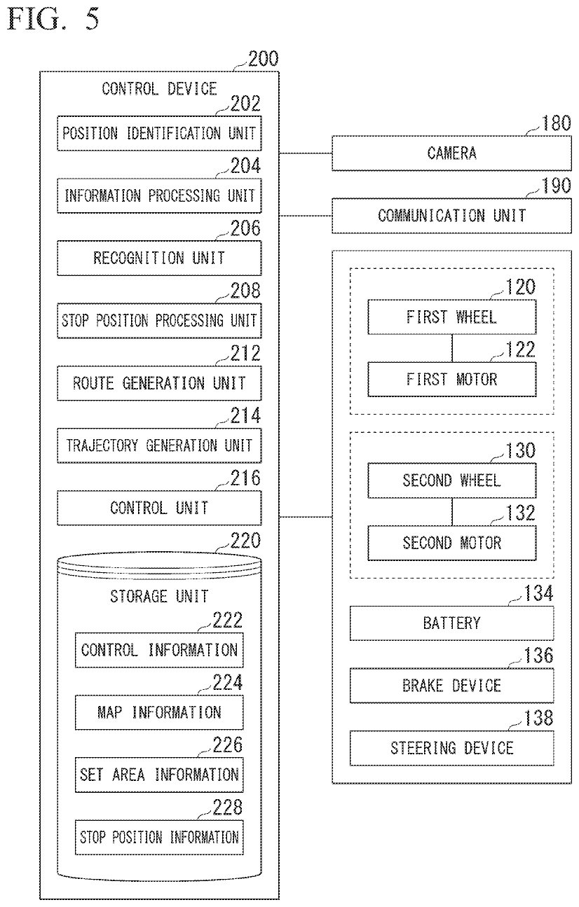

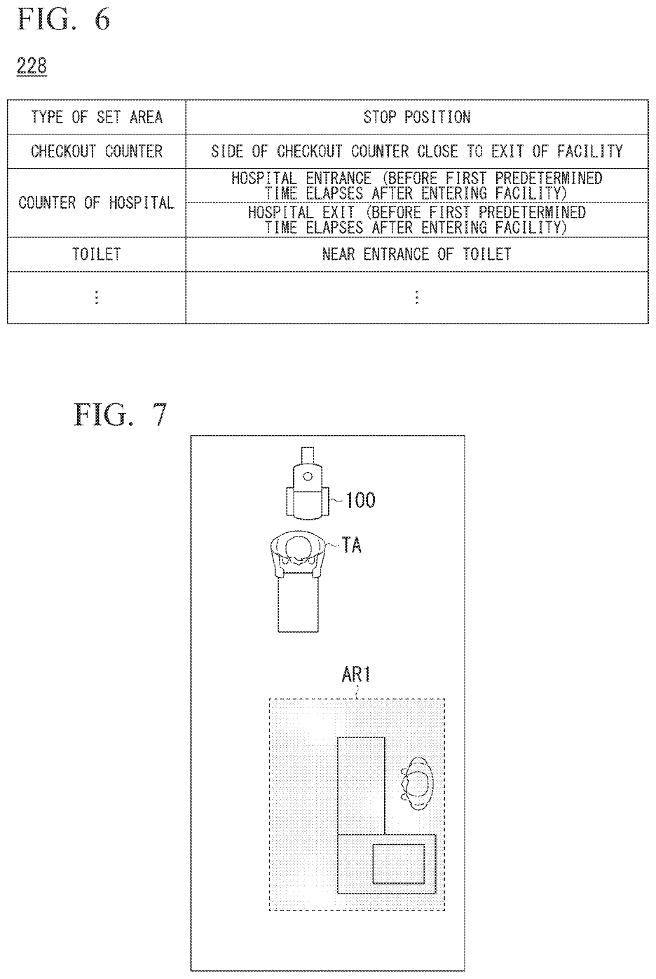

The stop position information 228 is information in which a stop position of the mobile object 100 based on a type of a set area is defined. FIG. 6 is a diagram illustrating an example of details of the stop position information 228. The stop position information 228 is, for example, information in which a type of a set area and a stop position are correlated. For example, when a type of a set area is a checkout counter, a position close to an exit of the facility at which a checkout counter is installed is a stop position. For example, when a type of a set area is a counter of a hospital and a first predetermined time has not passed yet after a user has entered the hospital, the stop position is a first position close to an entrance of the hospital. For example, when a type of a set area is a counter of a hospital and a second predetermined time has passed after a user has entered the hospital, the stop position is a second position close to an exit of the hospital. The first position may be closer to the entrance of the facility than the second position, and the second position may be closer to the exit of the facility than the first position. The stop position is a position which is determined with respect to the set area. For example, the stop position may be determined such as a position at a predetermined distance in the x direction from the set area or may be determined such as a position at a predetermined distance from the set area toward a reference position (for example, the entrance/exit of the facility). When an obstacle is present at a stop position, the mobile object 100 may correct a position at a predetermined distance from the obstacle to the stop position.

The position identification unit 202 identifies the position of the mobile object 100. The position identification unit 202 acquires position information of the mobile object 100 using a global positioning system (GPS) device (not illustrated) provided in the mobile object 100. The position information may be, for example, two-dimensional map coordinates or latitude and longitude information. The position identification unit 202 may estimate the position of the mobile object 100 at the same time as preparing an environmental map according to a technique such as so-called SLAM using a camera image captured by the camera 180 or a sensor such as a Lidar.

The information processing unit 204 manages, for example, information acquired from the terminal device 2, the management device 10, or the information providing device 30.

The recognition unit 206 recognizes states such as a position (a distance from the mobile object 100 and a direction with respect to the mobile object 100), speed, and acceleration of an object near the mobile object 100, for example, on the basis of an image captured by the camera 180. The object includes a traffic participant and an obstacle present in a facility or a road. The recognition unit 206 recognizes and tracks a user of the mobile object 100. For example, the recognition unit 206 tracks a user on the basis of an image in which the user is captured (for example, a face image the user) and which has been registered when the user uses the mobile object 100 or a face image of the user (or a feature quantity acquired from the face image of the user) provided by the terminal device 2 or the management device 10. The recognition unit 206 recognizes a gesture adopted by the user. A detection unit other than the camera such as a radar device or a LIDAR device may be provided in the mobile object 100. In this case, the recognition unit 206 recognizes a surrounding situation of the mobile object 100 using a detection result from the radar device or the LIDAR device instead of (or in addition to) an image.

When a target pedestrian enters a set area which the mobile object 100 is prohibited from entering, the stop position processing unit 208 determines a stop position other than the set area as a stop position based on the type of the set area. Details of this process will be described later.

The route generation unit 212 generates a route to a destination designated by the user. The destination may be a place of a product or a place of a facility. In this case, by allowing the user to designate a product or a facility, the mobile object 100 sets a place of the designated product or facility as the destination. The route is a route along which the mobile object can reasonably reach the destination. For example, a distance to the destination, a time until the mobile object reaches the destination, or easy passage of the route are scored, and a route in which the scores and a total score of the stores are equal to or greater than a threshold value is derived.

The trajectory generation unit 214 generates a trajectory along which the mobile object 100 will move in the future, for example, on the basis of the gesture of the user, the destination set by the user, a nearby object, a position of the user. The trajectory generation unit 214 generates a trajectory such that the mobile object 100 can move smoothly to the destination. The trajectory generation unit 214 generates a trajectory based on behavior of the mobile object 100, for example, on the basis of predetermined correspondence between a gesture and behavior or generates a trajectory for moving to the destination while avoiding the nearby object. The trajectory generation unit 214 generates, for example, a trajectory for following a user which is being tracked or a trajectory for guiding the user. The trajectory generation unit 214 generates, for example, a trajectory corresponding to behavior based on a preset mode. The trajectory generation unit 214 generates a plurality of trajectories corresponding to the behavior of the mobile object 100, calculates a risk for each trajectory, and employs a trajectory satisfying a preset reference as a trajectory along which the mobile object 100 will move when a total value of the calculated risks or the risk for each trajectory point satisfies the preset reference (for example, when the total value is equal to or less than a threshold value Th1 and the risks of the trajectory points are equal to or less than a threshold value Th2). For example, the risks are likely to increase as a distance between the trajectory (trajectory points of the trajectory) and an obstacle decreases and to decrease as the distance between the trajectory and the obstacle increases.

The control unit 216 controls the motors (the first motor 122 and the second motor 132), the brake device 136, and the steering device 138 such that the mobile object 100 travels along the trajectory satisfying the preset reference. The control unit 216 stops following the target pedestrian and moves the mobile object 100 to the stop position.

### Control Based on Type of Set Area

When a pedestrian enters a set area which the mobile object 100 is prohibited from entering, the control device 200 identifies the type of the set area, determines a stop position based on the identified type of the set area, stops following the pedestrian, and moves the mobile object to the determined stop position. The stop position based on the type of the set area is a position near the set area which another pedestrian is estimated not to be hindered from entering. The stop position is, for example, a position near an entrance/exit of the set area, a position other than the entrance/exit, or a position which is separated by a predetermined distance from the set area. The stop position may be a predetermined range which is determined according to the area of the set area, the size of the mobile object, and the like.

The stop position processing unit 208 recognizes the type of the set area on the basis of a type of an object recognized by the recognition unit 206. For example, the stop position processing unit 208 recognizes a checkout counter, a shopping cart, a shopping bag, a counter of a facility such as a hospital, a toilet, and the like as a type of an object. The stop position processing unit 208 recognizes the type of the set area according to the recognized type of the object and identifies a stop position based on the type of the set area with reference to the stop position information 228. An object indicating a set area may be an object other than the aforementioned object. In this case, the different types of objects and the stop position are defined in the stop position information 228.

The stop position processing unit 208 may identify the type of the set area on the basis of the position of the mobile object 100 and the map information 224 instead of the recognition result from the recognition unit 206. For example, the map information 224 stores information in which a position of a set area and a type of the set area are correlated. The stop position processing unit 208 may identify the type of the set area using the recognition result from the recognition unit 206 and the position information. The stop position processing unit 208 may identify the type of the set area when the results of the aforementioned two processes match and identify the type of the set area using a process result with a preset high priority when both do not match.

### Situation 1

When the recognition unit 206 recognizes a checkout counter, a shopping cart, and a shopping bag and recognizes that a set area is the checkout counter, the control device 200 determines a stop position at a position on an exit side of a facility in which the checkout counter is installed and moves the mobile object to the stop position.

FIG. 7 is a (first) diagram illustrating Situation 1. The mobile object 100 captures an image in the horizontal direction with respect to the ground surface, and a view when the ground surface is seen from above is illustrated in the example of FIG. 7 for the purpose of easy explanation. The same is true in other drawings. The mobile object 100 follows a user TA. The user TA approaches the checkout counter. When the checkout counter is recognized, the control device 200 sets a set area based on the checkout counter. As illustrated in FIG. 7, a preset area including the checkout counter is set as a set area AR1.

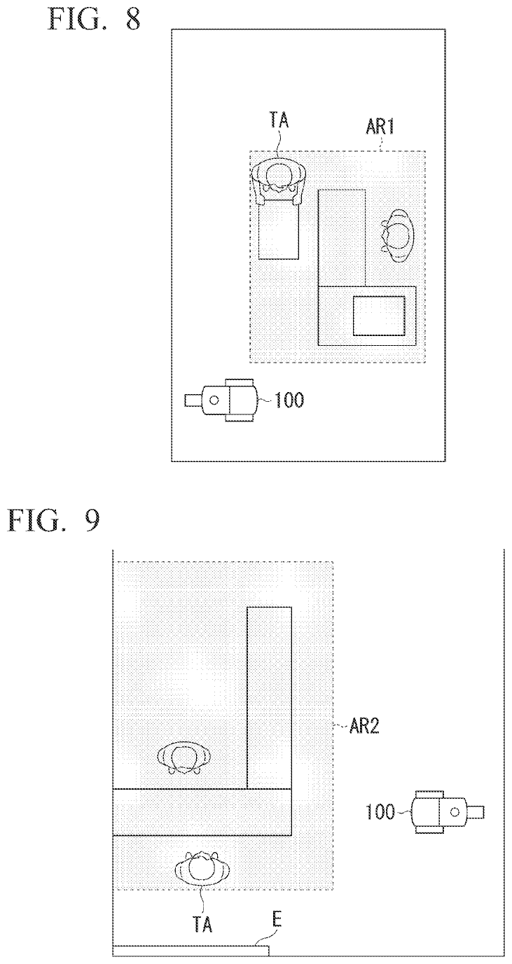

FIG. 8 is a (second) diagram illustrating Situation 1. When the user TA enters the set area AR1 from the position illustrated in FIG. 7, the control device 200 does not allow the mobile object 100 to enter the set area AR1, stops the mobile object 100 following the user TA, and allows the mobile object 100 to overtake the user TA. The control device 200 moves the mobile object 100 to a stop position closer to an exit of the facility than the user TA and stops the mobile object 100 at the stop position. The stop position may be a position on the exit side of the checkout counter instead of the position close to the exit of the facility. Thereafter, when the user TA exits the set area AR1 and approaches the exit, the control device 200 causes the mobile object 100 to follow the user TA. For example, the control device 200 stops the mobile object 100 at the stop position with entrance of the user TA into the set area AR1 and then restarts the mobile object 100 following the user TA when the user TA exits the set area AR1. In this case, for example, the mobile object 100 is prohibited from entering the set area AR1 and restarts following. Accordingly, a likelihood of interference with another user is decreased.

As described above, the control device 200 can cause the mobile object 100 to wait for the user at the stop position appropriate according to behavior of the user TA. Accordingly, it is possible to curb interference of the mobile object 100 with another traffic participant or movement of the user TA, and the mobile object 100 can smoothly follow the user after the user has exited the set area.

### Situation 2

When a user or a mobile object 100 enters a set area, the control device 200 may determine a stop position on the basis of a time period from a time point at which the user or the mobile object 100 has entered a facility of the set area to a time point at which the user has entered the set area. For example, the stop position may be set to a first stop position when the first time does not elapse after the user or the mobile object 100 enters the facility of the set area (immediately after entering the facility), and the stop position may be set to a second stop position different from the first stop position when the first time elapses after the user or the mobile object 100 has entered the facility of the set area (when a brief time elapses after entering the facility). When an entrance and an exit are the same, the first stop position is, for example, a position farther from the entrance/exit than the second stop position. When the entrance and the exit are different, the first stop position is, for example, a position separated from the entrance, a position separated from the exit, a position separated from the entrance and the exit, or a position separated more inwardly than the user. The second stop position is, for example, a position closer to the exit than the first stop position.

When the set area is a counter and a pedestrian enters the set area based on the counter and when a first predetermined time does not elapse after the user or the mobile object 100 enters the facility in which the counter is installed, the control device 200 determines a position farther from the entrance of the facility than the pedestrian as the stop position and moves the mobile object 100 to the stop position. When the set area is a counter and a pedestrian enters the set area based on the counter and when a second predetermined time elapses after the user or the mobile object 100 enters the facility in which the counter is installed, the control device 200 determines a position closer from the exit of the facility than the pedestrian as the stop position and moves the mobile object 100 to the stop position.

### Situation 2-1

FIG. 9 is a diagram illustrating Situation 2-1. Situation 2-1 is a situation in which a user TA and a mobile object 100 visit a facility such as a hospital. The mobile object 100 follows the user TA. The user TA enters the facility and approaches a counter. The control device 200 recognizes the counter and sets a set area AR2 based on the counter. As illustrated in FIG. 9, a preset area including the counter is set as the set area AR2.

In Situation 2-1, since a first predetermined time does not elapse after the user TA enters the facility, the control device 200 determines a position farther from an entrance E of the facility than the user TA as the stop position and moves the mobile object 100 to the stop position. In the example illustrated in FIG. 9, the mobile object 100 stops at the stop position. Thereafter, when the user TA moves away from the counter and starts movement, the control device 200 causes the mobile object 100 to follow the user TA.

As described above, the control device 200 can cause the mobile object to wait for the user at the stop position suitable for behavior of the user TA. Since the time at which the user has entered the facility is considered, the mobile object 100 waits for the user at the stop position based on next behavior of the user. Accordingly, it is possible to curb interference of the mobile object 100 with movement of another user or the user and to allow the mobile object 100 to smoothly follow the user.

### Situation 2-2

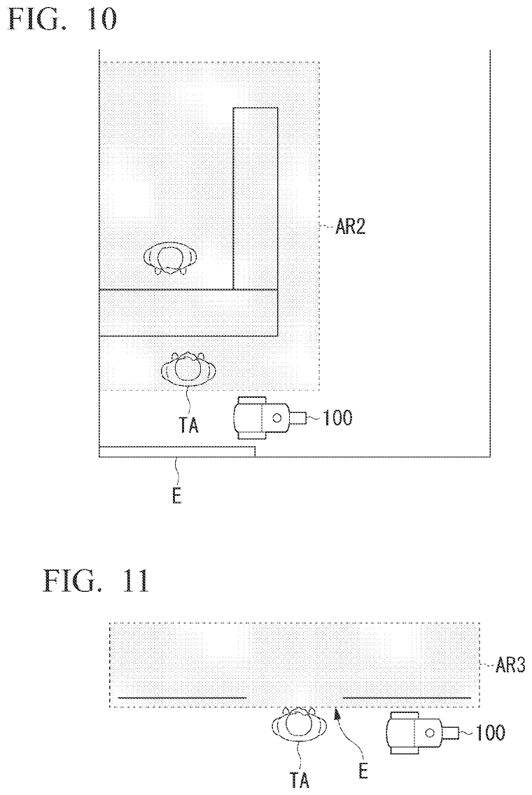

FIG. 10 is a diagram illustrating Situation 2-2. Differences from Situation 2-1 will be mainly described. A mobile object 100 follows a user TA. The user TA approaches a counter when a second predetermined time elapses after the user TA enters the facility. The second predetermined time is longer than the first predetermined time. The control device 200 recognizes the counter and sets a set area AR2 based on the counter.

In Situation 2-2, since the second predetermined time elapses after the user TA enters the facility, the control device 200 determines a position closer to the entrance E than the user TA as the stop position and moves the mobile object 100 to the stop position. In the example illustrated in FIG. 10, the mobile object 100 stops at the stop position. Thereafter, when the user TA moves away from the counter and starts movement, the control device 200 causes the mobile object 100 to follow the user TA.

In this example, the control device 200 determines the stop position on the basis of the time and may determine the stop position on the basis of a moving direction of the user instead (or in addition). For example, the control device 200 may determine the stop position in front of or behind the user in the moving direction of the user. For example, the stop position based on the type of the set area is a stop position in front of or behind the user in the moving direction of the user, and this stop position is a position which varies depending on the type of the set area. For example, the stop position is a position based on the type of the set area in front of or behind the user in the moving direction of the user. Accordingly, it is possible to achieve the aforementioned advantages.

### Situation 3

When the set area is recognized as a toilet, the control device 200 determines a predetermined area before the toilet as a stop position and moves the mobile object to the stop position. The predetermined area before the toilet is an area outside of the toilet and an area in a predetermined range from an entrance/exit of the toilet. FIG. 11 is a diagram illustrating Situation 3. Situation 3 is a situation in which a user TA approaches an entrance of the toilet. The mobile object 100 follows the user TA. The user TA approaches a set area based on the toilet. The control device 200 recognizes the entrance of the toilet on the basis of an indication of the toilet or the like and sets a set area AR3 based on the toilet. As illustrated in FIG. 11, a preset area including the toilet and the entrance E of the toilet is set as the set area AR3.

A user enters the set area AR3. The control device 200 moves the mobile object 100 to a stop position which is an area before the entrance E of the toilet. In the example illustrated in FIG. 11, the mobile object 100 stops at the stop position. Thereafter, when the user TA exits the entrance E of the toilet, the control device 200 recognizes the user TA and causes the mobile object 100 to follow the user TA.

As described above, the control device 200 can cause the mobile object 100 to wait for the user at the stop position appropriate for behavior of the user TA. Accordingly, it is possible to curb interference of the mobile object 100 with movement of another user or the user.

### Flowchart

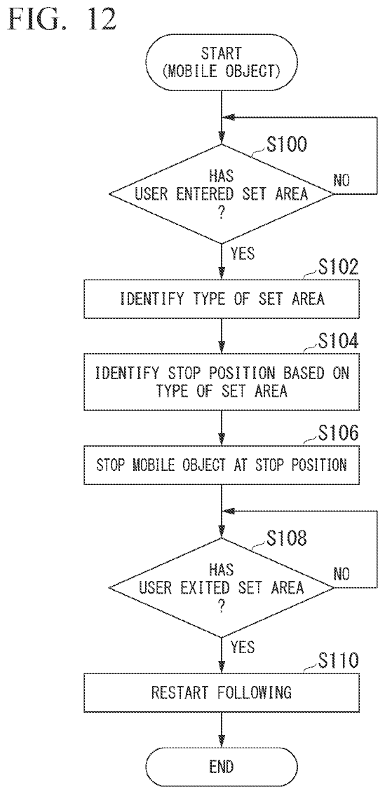

FIG. 12 is a flowchart illustrating an example of a process flow that is performed by the control device 200. First, the control device 200 determines whether a user has entered a set area (Step S100). When the user has entered the set area, the control device 200 identifies a type of the set area (Step S102). Then, the control device 200 identifies a stop position based on the type of the set area (Step S104). In this process, when the set area is a predetermined counter, the stop position is determined in consideration of a time period from a time point at which the user has visited the facility to a time point at which the user has entered the set area (or a time period up to now). The stop position is appropriately adjusted on the basis of a position of an object. For example, when an object is present at the stop position or near the stop position, the control device 200 determines a position separated by a predetermined distance from the object as the stop position. Then, the control device 200 causes the mobile object 100 to move to the stop position and to stop at that position (Step S106).

Then, the control device 200 determines whether the user has exited the set area (Step S108). When the user has exited the set area, the control device 200 causes the mobile object 100 to restart following the user (Step S110). In this way, this routine of the flowchart ends.

According to the aforementioned embodiment, when a target pedestrian enters a set area which the mobile object 100 is prohibited from entering, the control system can determine a stop position based on a surrounding environment by determining the stop position other than the set area as the stop position based on the type of the set area, stopping following the target pedestrian, and moving the mobile object 100 to the determined stop position.

The aforementioned embodiment can be expressed as follows.

A control system including:
a storage medium storing computer-readable instructions; and
one or more processors connected to the storage medium,
wherein the one or more processors execute the computer-readable instructions to perform:
   controlling a mobile object that is able to move autonomously in an area in which a pedestrian is able to move and moves to follow a target pedestrian;
   recognizing an object near the target pedestrian and the mobile object;
   determining a stop position other than a set area which the mobile object is prohibited from entering as a stop position based on a type of the set area when the target pedestrian enters the set area; and
   stopping following the target pedestrian and moving the mobile object to the determined stop position.

While an embodiment of the present invention has been described above, the present invention is not limited to the embodiment and can be subjected to various modifications and substitutions without departing from the gist of the present invention.

What is claimed is:

1. A control system for controlling a mobile object that is able to move autonomously in an area in which a pedestrian is able to move and moves to follow a target pedestrian, the control system comprising:
a storage medium storing computer-readable instructions; and
one or more processors connected to the storage medium,
wherein the one or more processors execute the computer-readable instructions to perform:
recognizing an object near the target pedestrian and the mobile object;
determining a stop position other than a set area which the mobile object is prohibited from entering as a stop position based on a type of the set area when the target pedestrian enters the set area; and
stopping following the target pedestrian and moving the mobile object to the determined stop position.

2. The control system according to claim 1, wherein the one or more processors execute the computer-readable instructions to perform recognizing a type of the set area on the basis of a type of the recognized object or recognizing a type of the set area on the basis of a type of a set area which is correlated with a position of the mobile object in map information.

3. The control system according to claim 1, wherein the stop position based on a type of the set area is a position in the vicinity of the set area at which another pedestrian is estimated not to be hindered from entering the set area.

4. The control system according to claim 1, wherein the one or more processors execute the computer-readable instructions to perform:
determining a position on an exit side of a facility in which a checkout counter is installed or a position of an exit of the checkout counter as the stop position when a target object indicating that the set area is a set area for the checkout counter is recognized and the set area is recognized as a set area for the checkout counter; and
moving the mobile object to the stop position.

5. The control system according to claim 4, wherein the target object is a checkout counter or a shopping cart.

6. The control system according to claim 1, wherein the one or more processors execute the computer-readable instructions to perform determining the stop position according to a time after the target pedestrian or the mobile object has entered a facility of the set area and until the target pedestrian enters the set area when the target pedestrian or the mobile object enters the set area.

7. The control system according to claim 1, wherein the one or more processors execute the computer-readable instructions to perform determining a position farther from an entrance of a facility in which a counter is installed than the target pedestrian as the stop position when the set area is the counter of the facility, the target pedestrian enters a set area for the counter, and a predetermined first time does not elapse after the target pedestrian or the mobile object enters the facility.

8. The control system according to claim 1, wherein the one or more processors execute the computer-readable instructions to perform determining a position closer to an exit of a facility than the target pedestrian as the stop position when the set area is a counter of the facility, the target pedestrian enters a set area for the counter, and a predetermined second time or more elapses after the target pedestrian or the mobile object enters the facility.

9. The control system according to claim 1, wherein the one or more processors execute the computer-readable instructions to perform determining a position in front of or behind the target pedestrian in a moving direction of the target pedestrian as the stop position based on the type of the set area and other than the set area when the target pedestrian enters the set area which the mobile object is prohibited from entering.

10. The control system according to claim 1, wherein the one or more processors execute the computer-readable instructions to perform:
determining a predetermined area before a toilet as the stop position when the set area is recognized as the toilet; and
moving the mobile object to the stop position.

11. The control system according to claim 10, wherein the predetermined area before the toilet is an area outside of the toilet and within a predetermined range from an entrance of the toilet.

12. The control system according to claim 1, wherein the one or more processors execute the computer-readable instructions to perform causing the mobile object to restart following the target pedestrian when the target pedestrian exits the set area after the mobile object has stopped at the stop position with entering of the target pedestrian into the set area.

13. The control system according to claim 12, wherein the one or more processors execute the computer-readable instructions to perform causing the mobile object not to enter the set area and to restart following the target pedestrian when the target pedestrian exits the set area after the mobile object has stopped at the stop position.

14. A control method that is performed by a computer of a control system for controlling a mobile object that is able to move autonomously in an area in which a pedestrian is able to move and moves to follow a target pedestrian, the control method comprising:
recognizing an object near the target pedestrian and the mobile object;
determining a stop position other than a set area which the mobile object is prohibited from entering as a stop position based on a type of the set area when the target pedestrian enters the set area; and
stopping following the target pedestrian and moving the mobile object to the determined stop position.

15. A non-transitory computer storage medium storing a program causing a computer of a control system for controlling a mobile object that is able to move autonomously in an area in which a pedestrian is able to move and moves to follow a target pedestrian to perform:
a process of recognizing an object near the target pedestrian and the mobile object;
a process of determining a stop position other than a set area which the mobile object is prohibited from entering as a stop position based on a type of the set area when the target pedestrian enters the set area; and
a process of stopping following the target pedestrian and moving the mobile object to the determined stop position.

16. A mobile object that is able to move autonomously in an area in which a pedestrian is able to move and moves to follow a target pedestrian, the mobile object performing:
recognizing an object near the target pedestrian and the mobile object;
determining a stop position other than a set area which the mobile object is prohibited from entering as a stop position based on a type of the set area when the target pedestrian enters the set area; and
stopping following the target pedestrian and moving to the determined stop position.
